(19) United States
(12) Patent Application Publication
(10) Pub. No.: US 2014/0062134 A1
(43) Pub. Date: Mar. 6, 2014

(54) ENCLOSURE ARRANGEMENT FOR MACHINE

(71) Applicants: Michael John Braun, Oswego, IL (US); Kalpeshbhai Ghanshyambhai Patel, Streamwood, IL (US)

(72) Inventors: Michael John Braun, Oswego, IL (US); Kalpeshbhai Ghanshyambhai Patel, Streamwood, IL (US)

(73) Assignee: Catepillar Inc., Peoria, IL (US)

(21) Appl. No.: 13/600,433

(22) Filed: Aug. 31, 2012

(51) Int. Cl. B62D 25/08; B60H 3/06

(52) U.S. Cl. 296/190.09; 180/69.24

(57) ABSTRACT

An enclosure arrangement for a machine is provided. The enclosure arrangement includes a housing and a deck. The housing is configured to enclose work components of the machine. The housing includes multiple sidewalls, and a platform disposed above the sidewalls. The housing further includes one or more access doors associated with the platform and one or more sidewalls. The deck extends laterally from the sidewalls such that an operator supported on the deck may access the work components on opening the access doors.

### TECHNICAL FIELD

The present disclosure relates to an enclosure arrangement, and more particularly to an enclosure arrangement for a machine.

### BACKGROUND

U.S. Pat. No. 4,989,500 relates to a vehicle cab duct arrangement that allows an operator to gain access to two vents of an air circulation system from a single opening for maintenance or replacement of filters. Filters are received in both vents for removing impurities from the air. A fresh air vent has a removable grill that allows access to the filter, and the interior vent is spaced from the fresh air vent opening such that it is accessible from the opening so that the interior vent filter may also be removed for maintenance.

Conventional enclosure systems may be provided to enclose work components present in machines. Further, the enclosure systems may include access points for the operator to enter and perform various functions with the work components. However, the relative positioning of the access points may not offer a simultaneous access to the operator into two or more access points from a single position. Such simultaneous access functions may be required during overhauling or replacing certain work components enclosed within the enclosure system.

### SUMMARY

In one aspect, the present disclosure provides an enclosure arrangement for a machine. The enclosure arrangement includes a housing and a deck. The housing is configured to enclose work components of the machine. The housing includes multiple sidewalls, and a platform disposed above the sidewalls. The housing further includes one or more access doors associated with the platform and one or more sidewalls. The deck extends laterally from the sidewalls such that an operator supported on the deck may access the work components on opening the access doors.

In another aspect, the present disclosure provides a machine. The machine includes an engine, work components associated with the engine, and an enclosure arrangement. The enclosure arrangement includes a housing and a deck. The housing is configured to enclose work components of the machine. The housing includes multiple sidewalls, and a platform disposed above the sidewalls. The housing further includes one or more access doors associated with the platform and one or more sidewalls. The deck extends laterally from the sidewalls such that an operator supported on the deck may access the work components on opening the access doors.

Other features and aspects of this disclosure will be apparent from the following description and the accompanying drawings.

### BRIEF DESCRIPTION OF THE DRAWINGS

FIG. 1 is a side view of an exemplary machine in accordance with an embodiment of the present disclosure;

FIG. 2 is a top view of the machine;

FIG. 3 is a top perspective view of an enclosure arrangement with access doors open;

FIG. 4 is a top perspective view of the enclosure arrangement with a secondary access door open; and

FIG. 5 is a breakaway perspective view of the machine showing a cabin air filter.

### DETAILED DESCRIPTION

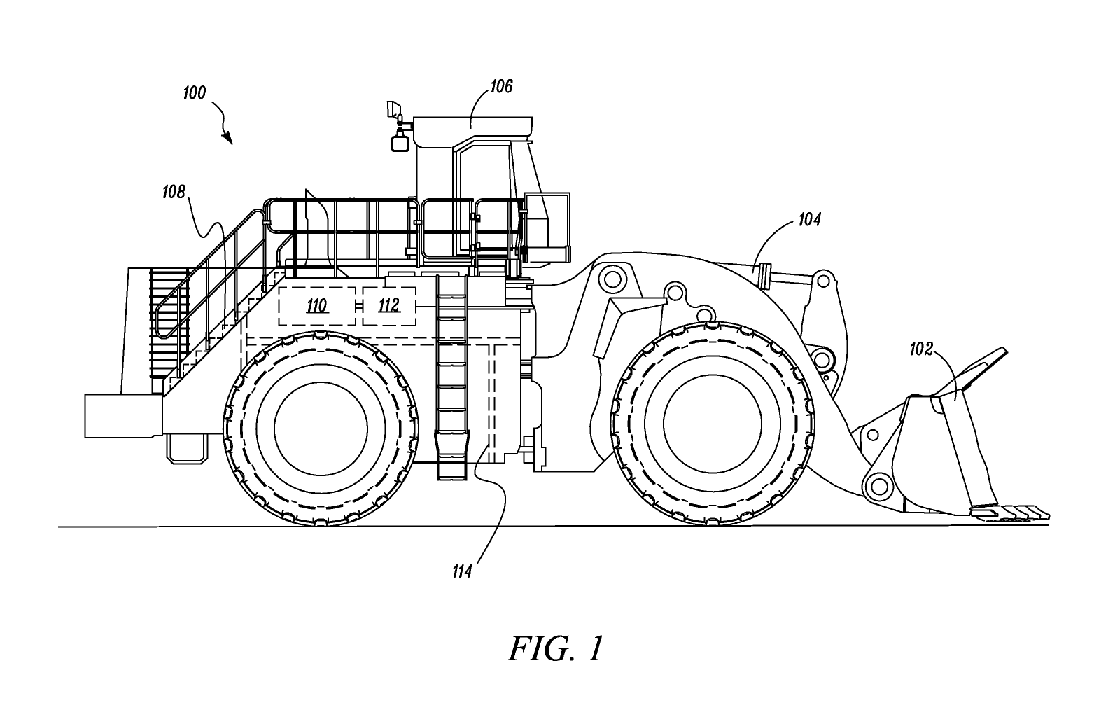

The present disclosure relates to an enclosure arrangement for a machine. FIG. 1 illustrates a machine 100 in accordance with an embodiment of the present disclosure. The machine 100 may be a wheeled industrial vehicle, for example, but not limited to, mining trucks, loaders, material handlers, wheeled dozers, and the like. In an embodiment, as shown in FIG. 1, the machine 100 may embody a large wheel loader used to load or unload material in construction areas with the help of a shovel 102. The shovel 102 may be manipulated by at least a pair of power pistons 104 driven by a pressurized fluid. The machine 100 disclosed herein may include a cabin 106, and one or more stairways 108 leading to the cabin 106.

The machine 100 includes an engine 110, work components 112 associated with the engine 110, and a frame 114. The engine 110 and the associated work components 112 may be mounted on the frame 114. The engine 110 may be a fuel based engine 110 and may generate power by combustion of natural resources such as gasoline, other petroleum products or liquid natural gas.

The work components 112, disclosed herein may represent mechanical or electrical systems that perform mechanical or electrical work in conjunction with the engine 110. In an embodiment, the mechanical systems may be sub-classified and understood to include pneumatic sub-systems or hydraulic sub-systems. Hence, work components 112, disclosed herein may be construed to broadly encompass systems or sub-systems that function together with the engine 110.

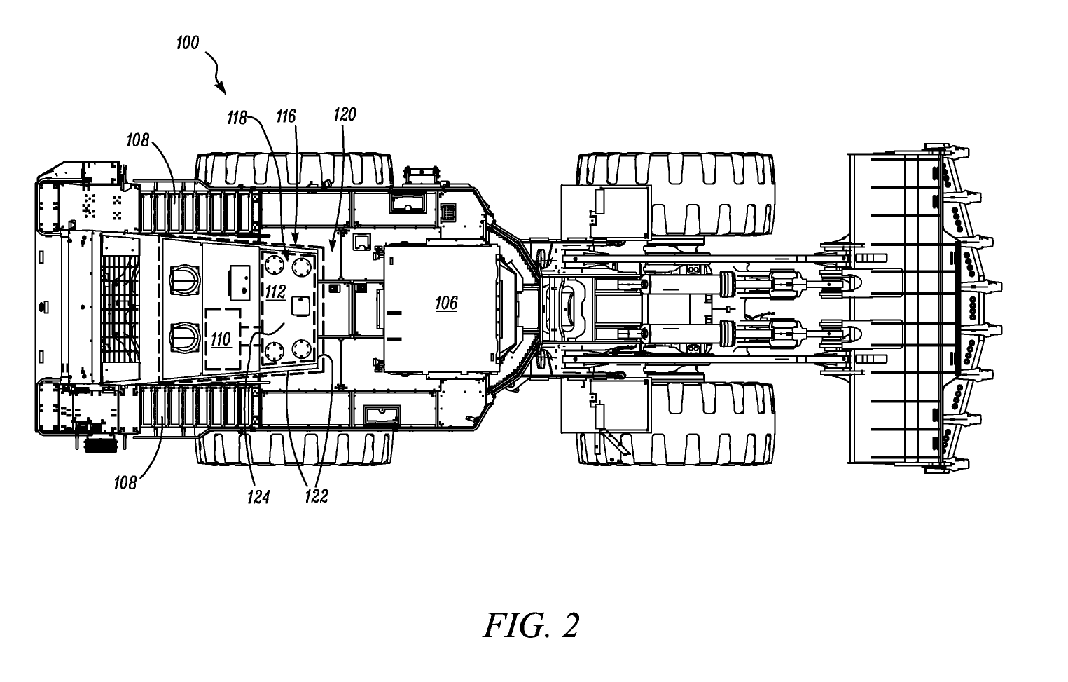

As shown in FIG. 2, the machine 100 further includes an enclosure arrangement 116. The enclosure arrangement 116 includes a housing 118 and a deck 120. The housing 118 is configured to enclose the work components 112. In an embodiment, the housing 118 is configured to enclose the engine 110 and the work components 112. The housing 118 includes multiple sidewalls 122, and a platform 124 disposed above the sidewalls 122.

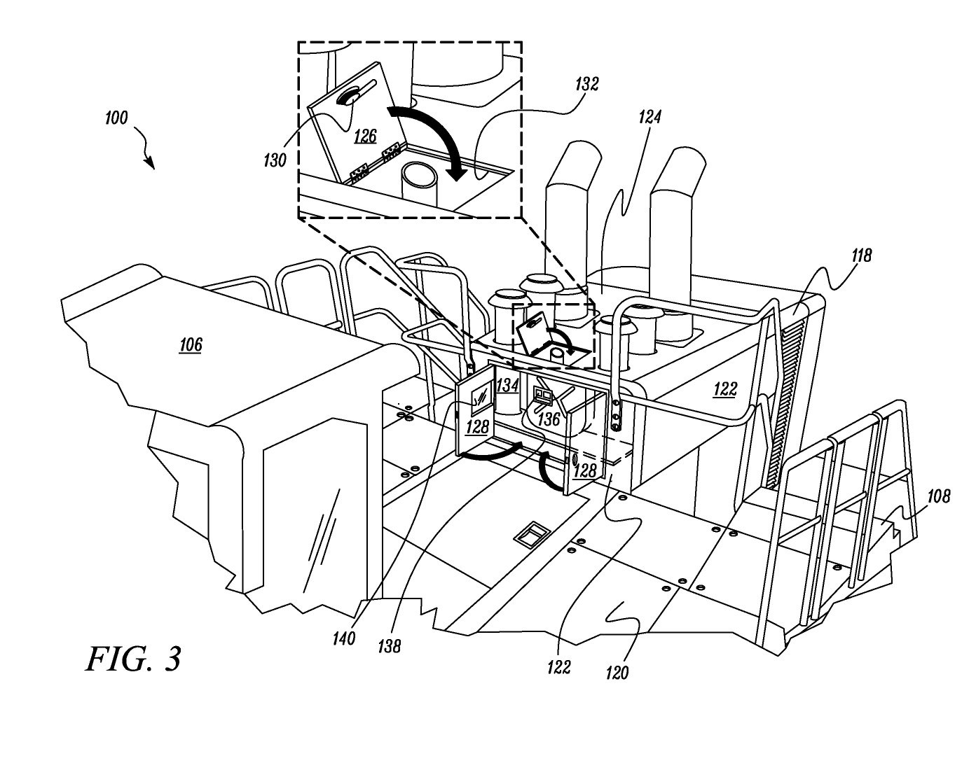

As can be seen from FIG. 3, the housing 118 includes one or more access doors 126 associated with the platform 124. The housing 118 further includes access doors 128 associated with the sidewalls 122. In an embodiment, the access doors 126, 128 may be hingedly connected to the platform 124 and one or more sidewalls 122. Although it is disclosed herein that the access doors 126, 128 may be hingedly connected to the platform 124 and the sidewalls 122, a person having ordinary skill in the art will acknowledge that the access doors 126, 128 may be connected to the platform 124 and one or more sidewalls 122 by other methods commonly known in the art. Therefore, it is to be understood that the hinged connection disclosed herein is only exemplary in nature and hence, does not limit the scope of this disclosure. In another embodiment as shown in FIG. 3, the access doors 126 associated with the platform 124 may include a spring latch 130 configured to releasably engage with an underside 132 of the platform 124.

As shown in FIG. 3, the deck 120 extends laterally from the sidewalls 122 such that an operator supported on the deck 120 may access the work components 112 on opening the access doors 126, 128. In an embodiment as shown in FIG. 3, the work components 112 may include at least one or more air filters 134, one or more hydraulic tanks 136, and an indicator. In this embodiment, the air filters 134 and hydraulic tanks 136 may be operatively connected to the engine 110.

In an embodiment, the hydraulic tank 136 is configured to store a coolant fluid (not shown) that helps cool down a temperature of the engine 110. In another embodiment, the hydraulic tank 136 may be a shunt tank connected to a main coolant reservoir (not shown). In this embodiment, the access door 126 may serve as a refill point for filling coolant liquid into the shunt tank disposed directly beneath the platform 124.

The indicator 138 may be operatively connected to the hydraulic tank 136 and may be configured to visually indicate a parameter associated with the hydraulic tank 136. In an embodiment, the indicator 138 may be a fluid level indicator configured to indicate a fluid level present in the hydraulic tank. The fluid level indicator may be of an analogue type or of a digital read-out type. Further, in this embodiment, the access door 128 may include one or more viewing windows 140 disposed relative to the indicator 138 such that the viewing window 140 may allow visibility of the indicator 138 to the operator when the access door 128 is in a closed position. In an embodiment, the viewing window 140 may be made of a transparent glass material. In another embodiment, the viewing window 140 may be made of a transparent plastic material.

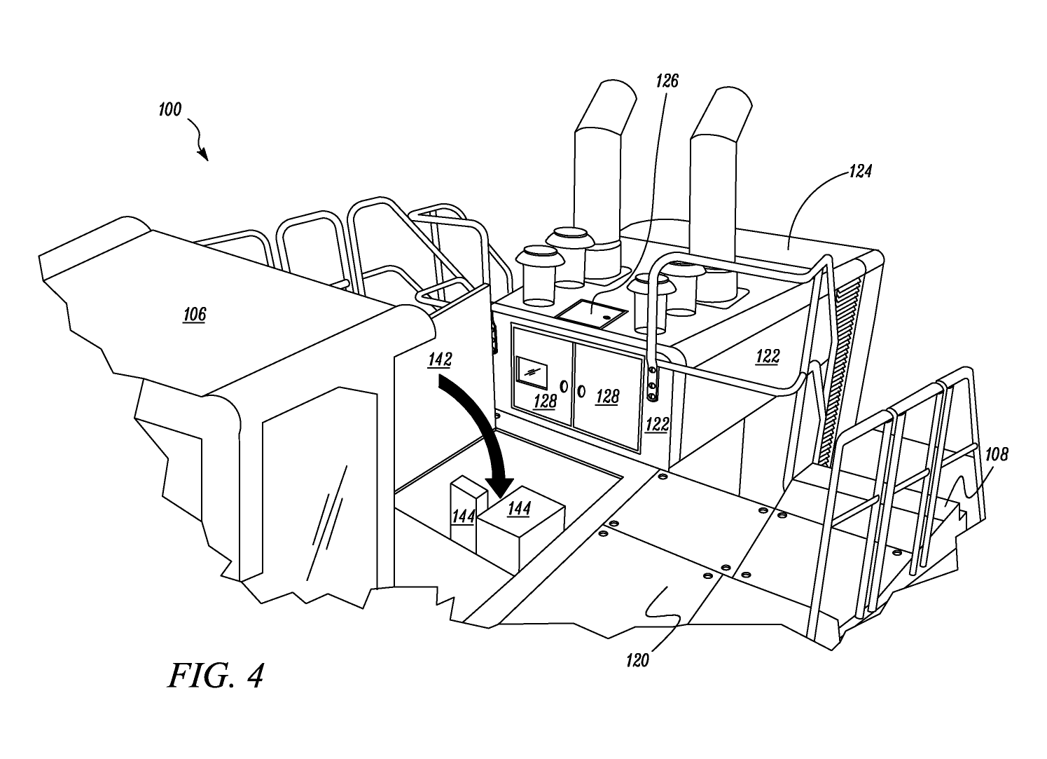

In an embodiment as shown in FIG. 4, the machine 100 may further include one or more secondary access doors 142 associated with the deck 120. In an embodiment, the secondary access doors 142 may be hingedly connected to the deck 120. These secondary access doors 142 may be configured to allow access to an underlying set of work components 144, separate from the work components 112 previously disclosed herein. In an embodiment, the work components 144 may embody hydraulic filters that may be used for filtration of fluid circulating between a pump (not shown) and the power pistons 104 of the shovel 102.

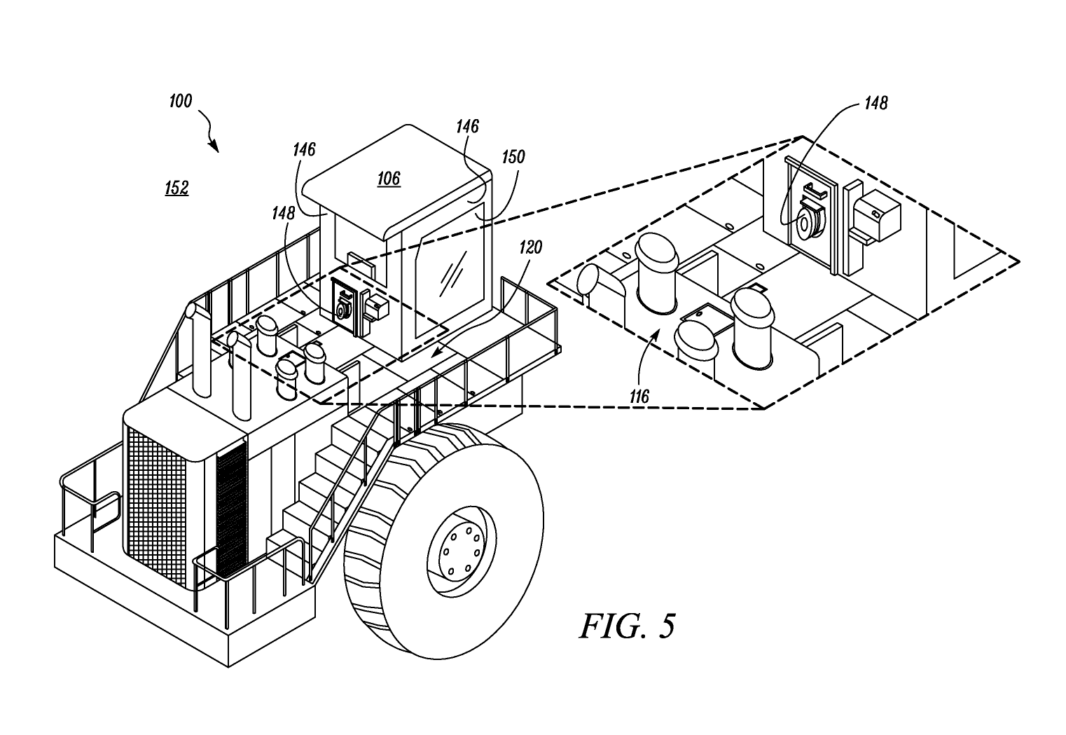

As seen in FIG. 5, the cabin 106 disposed on the deck 120 may include one or more sides 146. In an embodiment as shown in FIG. 5, one or more cabin air filters 148 may be positioned on a side of the cabin 146 and disposed proximal to the enclosure arrangement 116. In this embodiment, the operator supported on the deck 120 may access the cabin air filters 148 and the work components 112, 144 within the enclosure arrangement 116 in a substantially simultaneous manner. In an embodiment, the cabin air filters 148 may be associated with an air conditioning system (not shown) of the cabin 106. In another embodiment, the cabin air filters 148 may be associated with a stand-alone ventilating system (not shown) of the cabin 106. The stand-alone ventilating system disclosed in the preceding embodiment may represent a ventilating system that is configured to provide simple exchange of gases between an interior 150 of the cabin 106 and the atmosphere 152.

### INDUSTRIAL APPLICABILITY

Conventional enclosure systems may be provided to enclose work components 112 present in machines 100. Further, the enclosure systems may include access points for the operator to enter and perform various functions with the work components 112. The ergonomics associated with such enclosure systems may be influenced by the positioning of the enclosure system on the machine 100. Moreover, constructional details of the enclosure system such as size, shape, and a location of the access points on the enclosure system may further determine an amount of fatigue experienced by the operator.

Typically, the enclosure systems may be positioned near the stairways 108, the cabin 106, and other structures of the machine 100. Further, the positioning of the various access points on the enclosure system may be complex, for example, one on either side of the enclosure facing the stairways 108. Therefore, these factors may limit a possibility of the operator in accessing the work components 112 via multiple access points simultaneously from a single position. The simultaneous access to one or more work components 112 via multiple access points from a single position of the operator may be required when performing a service or overhaul routine on the machine 100. However, this may not be possible when using conventional enclosure systems since the positions of the multiple access points on the enclosure system may not be proximal enough to the operator to access two or more access points simultaneously from a single position. Conversely, the operator may require moving from one position to another position in order to access the work components 112 via different access points.

Furthermore, the enclosure systems may include opaque sides that lack see-through areas on them. These see-through areas may allow the operator to visually monitor work components 112, such as indicators 138. However, in the absence of such see-through areas, the conventional enclosure systems may entail greater effort from the operator in opening such opaque sides and visually monitoring the work components 112.

The enclosure arrangement 116 of the present disclosure may find potential application in any congested space where it is desirable to enclose work components 112 within the congested space and also allow the operator to be able to access the work components 112, 144. The enclosure arrangement 116 disclosed herein may further allow the operator to simultaneously access the work components 112/144 from two or more access doors 126 & 128/142 while the operator may be positioned at a single position on the deck 120. Furthermore, in specific embodiments where cabin air filters 148 are provided, the operator may access the cabin air filters 148 in addition to the work components 112, 144. The aforementioned access may be accomplished by the operator from a single or unitary position on the deck 120 due to the proximity of the cabin air filters 148 and the work components 112, 144.

In a specific application of overhauling or replacing work components 112 such as, a pair of in-line air filters 134 positioned on either side of the hydraulic tank 136 as shown in FIGS. 2-4, the operator may merely position himself on the deck 120 and open the access doors 126, 128 to gain access to the air filters 134. Subsequently, the operator may execute the overhaul or replacement operation with ease while stands at the single position on the deck 120. Similarly, if the operator may wish to replace the cabin air filters 148, he may turn himself on the deck 120 to face the side 146 of the cabin 106 and merely access the cabin air filters 148 to perform the required replacement functions.

In a conventional enclosure system or setup, the aforesaid function of overhauling or replacement may have entailed the operator to remove panels on the enclosure system from various sides. The various sides, disclosed herein, may refer to sides facing each stairway 108 of the machine 100, a side facing the cabin 106 of the machine 100 and the like. Therefore, the operator would experience fatigue in intermittently moving from one side to another side during the overhauling operation. Although it may not be readily obvious to one skilled in the art, the enclosure arrangement 116 of the present disclosure may cause lesser fatigue to the operator during overhauling operations. Further, in embodiments where the access door 128 includes viewing windows 140, the operator may see-through the viewing window 140 and visually monitor the work components 112 such as indicators 138. Hence, time required for monitoring the work components 112 may be reduced and the work components 112 may be monitored by the operator easily.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. An enclosure arrangement for a machine, the enclosure arrangement comprising:
a housing configured to enclose work components of the machine, the housing including:
a plurality of sidewalls;
a platform disposed above the sidewalls; and
one or more access doors associated with the platform and one or more sidewalls; and
a deck extending laterally from the sidewalls such that an operator supported on the deck may access the work components on opening the access doors.

2. The enclosure arrangement of claim 1, wherein the access doors are hingedly connected to the platform and one or more sidewalls.

3. The enclosure arrangement of claim 1, wherein the access doors associated with the platform include a spring latch configured to releasably engage with an underside of the platform.

4. The enclosure arrangement of claim 1, wherein the housing is configured to enclose the work components including at least:
one or more air filters operatively connected to an engine;
one or more hydraulic tanks operatively connected to an engine; and
at least one indicator operatively connected to the hydraulic tank, the indicator configured to visually indicate a parameter associated with the hydraulic tank.

5. The enclosure arrangement of claim 4, wherein the hydraulic tank is configured to store a coolant fluid.

6. The enclosure arrangement of claim 4, wherein the indicator is a fluid level indicator.

7. The enclosure arrangement of claim 4, wherein the access door includes one or more viewing windows disposed relative to the indicator.

8. The enclosure arrangement of claim 1 further comprising one or more secondary access doors associated with the deck.

9. The enclosure arrangement of claim 8, wherein the secondary access doors are hingedly connected to the deck.

10. A machine comprising:
an engine;
work components associated with the engine; and
an enclosure arrangement including:
a housing configured to enclose the work components, the housing including:
a plurality of sidewalls;
a platform disposed above the sidewalls; and
one or more access doors associated with the platform and one or more sidewalls; and
a deck extending laterally from the sidewalls such that an operator supported on the deck may access the work components on opening the access doors.

11. The machine of claim 10, wherein the access doors are hingedly connected to the platform and one or more sidewalls.

12. The machine of claim 10, wherein the access doors associated with the platform include a spring latch configured to releasably engage with an underside on the platform.

13. The machine of claim 10, wherein the work components include at least:
one or more air filters operatively connected to the engine;
one or more hydraulic tanks operatively connected to the engine; and
at least one indicator operatively connected to the hydraulic tank, the indicator configured to visually indicate a parameter associated with the hydraulic tank.

14. The machine of claim 13, wherein the hydraulic tank is configured to store a coolant fluid.

15. The machine of claim 13, wherein the indicator is a fluid level indicator.

16. The machine of claim 13, wherein the access door includes one or more viewing windows disposed relative to the indicator.

17. The machine of claim 10 further comprising one or more secondary access doors associated with the deck.

18. The machine of claim 17, wherein the secondary access doors are hingedly connected to the deck.

19. The machine of claim 11 further comprising:
a cabin disposed on the deck; and
one or more cabin air filters positioned on a side of the cabin, the cabin air filters disposed proximal to the enclosure arrangement such that an operator supported on the deck may access the cabin air filters and the work components within the enclosure arrangement in a substantially simultaneous manner.

20. The machine of claim 19, wherein the cabin air filters are associated with an air conditioning system of the cabin.
